(19) United States
(12) Patent Application Publication
(10) Pub. No.: US 2015/0298513 A1
(43) Pub. Date: Oct. 22, 2015

(54) AIR-PRESSURE MONITORING DEVICE AND MALFUNCTION-DETERMINATION-THRESHOLD-VALUE DETERMINATION METHOD

(71) Applicant: TOYOTA JIDOSHA KABUSHIKI KAISHA, Toyota-shi, Aichi (JP)

(72) Inventor: Yuji Taki, Miyoshi-shi (JP)

(73) Assignee: TOYOTA JIDOSHA KABUSHIKI KAISHA, Toyota-shi, Aichi (JP)

(21) Appl. No.: 14/441,126

(22) PCT Filed: Nov. 28, 2012
(86) PCT No.: PCT/JP2012/080688

§ 371 Date: May 6, 2015

(51) Int. Cl. B60C 23/04; G01M 17/02

(52) U.S. Cl. CPC B60C 23/04; G01M 17/02

(57) ABSTRACT

A rotation angle velocity is acquired in each of a two-wheel high pressure state and a reference state of air pressures of respective four wheels, and a rotation angle velocity value and a resonant frequency are acquired. The rotation angle velocity value, etc, acquired in the two-wheel high pressure state and the rotation angle velocity value, etc, acquired in the reference state are compared with each other. When these values are generally equal to each other, it is determined that at least one of the values is not appropriate for the determination of the malfunction determination threshold value, and a preset value is determined to be used as the malfunction determination threshold value. When these values are different from each other, the malfunction determination threshold value is determined. The determination of the malfunction determination threshold value to an inappropriate value is thus avoided, reliably monitoring the air pressures.

### TECHNICAL FIELD

The present invention relates to an air-pressure monitoring device configured to monitor an air pressure in a tire of a wheel and a malfunction-determination-threshold-value determination method for determining a malfunction determination threshold value which is used when the air pressure in the tire is monitored.

### BACKGROUND ART

Patent Documents 1, 2 disclose an air-pressure monitoring device configured to monitor an air pressure in a tire of a wheel and a malfunction-determination-threshold-value determination method for determining a malfunction determination threshold value which is used when the air pressure in the tire is monitored. Patent Document 1 discloses determination of a malfunction determination threshold value based on a value related to air pressures in the case where air pressures of the respective front left and right and rear left and right wheels are in a first state and based on a value related to air pressures in the case where the air pressures of the respective front left and right and rear left and right wheels are in a second state different from the first state.

### PRIOR ART DOCUMENTS

### Patent Documents

Patent Document 1 (Japanese Patent Application Publication No. 2005-193712)

Patent Document 2 (Japanese Patent Application Publication No. 2010-151467)

### SUMMARY OF THE INVENTION

### Object of the Invention

An object of the present invention is to improve an air-pressure monitoring device, for example, to avoid determination of a malfunction determination threshold value to an inappropriate value.

### Means for Achieving Object and Effects

An air-pressure monitoring device according to the present invention uses a malfunction determination threshold value to monitor whether or not a plurality of wheels provided on a vehicle includes at least one wheel in which an air pressure in a tire is outside an appropriate range. The malfunction determination threshold value is acquired based on at least one of: a first adjustment air-pressure related value which is acquired based on first-state adjusted information indicating that a state of air pressures of a plurality of wheels has been adjusted to a first state and which is related to an air pressure of at least one of the plurality of wheels; and a second adjustment air-pressure related value which is acquired based on second-state adjusted information indicating that the state of the air pressures has been adjusted to a second state different from the first state and which is related to an air pressure of the at least one wheel, and it is determined whether determination of the malfunction determination threshold value is appropriate or not based on the first air-pressure related value and the second air-pressure related value. When it is determined that at least one of the first adjustment air-pressure related value and the second adjustment air-pressure related value is not appropriate for the determination of the malfunction determination threshold value, the determination of the malfunction determination threshold value is not executed based on the at least one of the first adjustment air-pressure related value and the second adjustment air-pressure related value, and when it is determined that at least one of the first adjustment air-pressure related value and the second adjustment air-pressure related value is appropriate for the determination of the malfunction determination threshold value, the determination of the malfunction determination threshold value is executed.

The first adjustment air-pressure related value is a value determined by the first state, and the second adjustment air-pressure related value is a value determined by the second state. In this case, since the first state and the second state differ from each other, the first adjustment air-pressure related value and the second adjustment air-pressure related value usually differ from each other.

In contrast, when the first adjustment air-pressure related value and the second adjustment air-pressure related value are generally equal to each other, the first state and the second state may be the same as each other. That is, the air pressures of the plurality of wheels are usually adjusted by an operator, and there is a possibility that the adjustment of the air pressures by the operator was inappropriate.

On the other hand, the malfunction determination threshold value is determined based on at least one of the first adjustment air-pressure related value acquired in the first state and the second adjustment air-pressure related value acquired in the second state, and accordingly in the case where the first state and the second state are the same, the malfunction determination threshold value cannot be determined to an appropriate value in some cases.

In view of the above-described situations, for example, when the first adjustment air-pressure related value and the second adjustment air-pressure related value are compared with each other and are generally equal to each other, it is determined that at least one of the first adjustment air-pressure related value and the second adjustment air-pressure related value is not appropriate for the determination of the malfunction determination threshold value, and the determination of the malfunction determination threshold value is not executed based on at least one of the first adjustment air-pressure related value and the second adjustment air-pressure related value. If each of the first adjustment air-pressure related value and the second adjustment air-pressure related value is a value which cannot be present in a corresponding one of the first state and the second state, the first adjustment air-pressure related value and the second adjustment air-pressure related value may be acquired in a third state which is different from the first state and the second state. Also in this case, it may be determined that the determination of the malfunction determination threshold value is not appropriate, and the determination of the malfunction determination threshold value may not be executed based on at least one of the first adjustment air-pressure related value and the second adjustment air-pressure related value.

In contrast, in the case where an absolute value of a difference between the first adjustment air-pressure related value and the second adjustment air-pressure related value is greater than a set value, it is estimated that the first state and the second state differ from each other, and it is determined that the determination of the malfunction determination threshold value is appropriate. In this case, the determination of the malfunction determination threshold value is executed based on at least one of the first adjustment air-pressure related value and the second adjustment air-pressure related value. The malfunction determination threshold value may be determined based on both of the first adjustment air-pressure related value and the second adjustment air-pressure related value, based on any one of the first adjustment air-pressure related value and the second adjustment air-pressure related value, or with consideration of another or other air-pressure related values (e.g., a third adjustment air-pressure related value).

As thus described, it is possible to reliably avoid determination of the malfunction determination threshold value to an inappropriate value, thereby increasing robustness.

### CLAIMABLE INVENTIONS

There will be described inventions recognized to be claimable in the present invention and features of the invention.

(1) An air-pressure monitoring device configured to use a malfunction determination threshold value to monitor whether there is at least one wheel in which an air pressure in a tire is outside an appropriate range among a plurality of wheels provided on a vehicle, the air-pressure monitoring device comprising:

an adjustment air-pressure related value acquirer configured to acquire an adjustment air-pressure related value, as an air-pressure related value related to an air pressure of at least one of the plurality of wheels, based on adjusted information indicating that a state of air pressures of the plurality of wheels has been adjusted to a predetermined state, the adjustment air-pressure related value acquirer being configured to acquire a first adjustment air-pressure related value as the adjustment air-pressure related value based on first adjusted information as the adjusted information which indicates that the state of the air pressures of the plurality of wheels has been adjusted to a first state, the adjustment air-pressure related value acquirer being configured to acquire a second adjustment air-pressure related value as the adjustment air-pressure related value based on second adjusted information as the adjusted information which indicates that the state of the air pressures of the plurality of wheels has been adjusted to a second state different from the first state; and

a malfunction determination threshold value determiner configured to perform:

when it is determined, based on the first adjustment air-pressure related value and the second adjustment air-pressure related value, that at least one of the first adjustment air-pressure related value and the second adjustment air-pressure related value is not appropriate for determination of the malfunction determination threshold value, not executing the determination of the malfunction determination threshold value based on the at least one of the first adjustment air-pressure related value and the second adjustment air-pressure related value; and

when it is determined, based on the first adjustment air-pressure related value and the second adjustment air-pressure related value, that the first adjustment air-pressure related value and the second adjustment air-pressure related value are appropriate for determination of the malfunction determination threshold value, executing the determination of the malfunction determination threshold value based on the at least one of the first adjustment air-pressure related value and the second adjustment air-pressure related value.

“The state of the air pressures of the plurality of wheels” may be expressed as a magnitude (which may be referred to as “air pressure value”) of an air pressure in a tire of each of the plurality of wheels (e.g., Pa, Pb, Pc, Pd) and may be expressed as an evaluation value used for determining whether the air pressure falls within the appropriate range or not. Also, the state of the air pressures of the plurality of wheels may be expressed as a relative relationship between the respective air pressures in the respective tires of the plurality of wheels (hereinafter may be referred simply as “air pressures”). Examples of this relationship include: a state in which the air pressures of the plurality of wheels are generally equal to each other in magnitude (e.g., Pa≈Pb≈Pc≈Pd); a state in which the air pressures are different from each other in magnitude (e.g., Pa≠Pb, Pb≠Pc, Pc≠Pd, Pa≠Pc, Pb≠Pd, Pa≠Pd); and a state in which an air pressure of at least one of the wheels is higher than an air pressure of each of the other wheel(s) (e.g., Pa≈Pb>Pc≈Pd). In the case where the state of the air pressure is expressed as the relative relationship, the air pressure value in each tire is ignored in some cases.

One example of “the value related to the air pressure of the at least one of the plurality of wheels” is a value determined by a magnitude of an air pressure in a tire of each of at least one wheel. Specific examples of the value include: a value representing vibration characteristics of the tire (e.g., a resonant frequency); and a dynamic load radius (which can be expressed as a rotation angle velocity). The resonant frequency is higher in the case where the air pressure is high than in the case where the air pressure is low. The dynamic load radius is larger in the case where the air pressure is high than in the case where the air pressure is low. Examples of the value further include: a value (e.g., the sum of resonant frequencies) determined by vibration characteristics of each of tires of two or more wheels and a predetermined arithmetic expression (a function); and a value (e.g., the sum of rotation angle velocities) determined by a dynamic load radius of each of tires of two or more wheels and a predetermined arithmetic expression (a function). Examples of the value further include a value which takes on a set value (e.g., about one) in the case where air pressures of two or more wheels are generally equal to each other in magnitude (in the case where air pressure values fall within a set range, i.e., a range in which it is possible to consider that the air pressure values are generally equal to each other) and which falls outside the set range determined by the set value (a range in which it is possible to consider that each air pressure is generally equal to the set value) when an air pressure of one of the two or more wheels is lower than that of each of the other wheel(s).

Examples of “the at least one of the plurality of wheels” include: all wheels in the case where a plurality of wheels are provided on the vehicle; some of the plurality of wheels (e. g., wheels located at diagonal positions, front wheels, and rear wheels); and one of the plurality of wheels.

“The adjusted information” may be produced by an operation of an operator under a predetermined rule and output, for example. In the case where no air pressure adjusting device is provided on the vehicle, the operator in most cases adjusts the respective air pressures in the tires of the plurality of wheels. After the air pressures are adjusted to the first state and the second state, when an operation with an operation member is performed under the rule (a pattern determined by the rule) (noted that examples of the operation include an operation of a touch panel of a display and an operation of switches, and the operation will be hereinafter abbreviated as “switch operation”, for example), first-state adjusted information and second-state adjusted information are produced and output.

“Monitoring whether there is at least one wheel in which an air pressure in a tire is outside the appropriate range among the plurality of wheels provided on the vehicle” includes at least one of monitoring whether an air pressure of each of the plurality of wheels is outside the appropriate range or not and monitoring whether or not there is at least one wheel whose air pressure is relatively lower by greater than or equal to a set pressure among the plurality of wheels. In the former case, a position of the wheel(s) whose air pressure is outside the appropriate range is identified, but in the latter case, a position of one or more wheels is not identified in some cases.

(2) The air-pressure monitoring device according to the above form (1), wherein the malfunction determination threshold value determiner comprises a comparison appropriateness determiner configured to compare the first adjustment air-pressure related value and the second adjustment air-pressure related value with each other to determine whether the determination of the malfunction determination threshold value is appropriate.

(3) The air-pressure monitoring device according to the above form (1) or (2), wherein the malfunction determination threshold value determiner comprises a related-value-difference-dependent appropriateness determiner configured to:

determine that at least one of the first adjustment air-pressure related value and the second adjustment air-pressure related value is not appropriate for the determination of the malfunction determination threshold value when the first adjustment air-pressure related value and the second adjustment air-pressure related value are equal to each other; and

determine that the first adjustment air-pressure related value and the second adjustment air-pressure related value are appropriate for the determination of the malfunction determination threshold value when the first adjustment air-pressure related value and the second adjustment air-pressure related value differ from each other.

(4) The air-pressure monitoring device according to any one of the above forms (1) through (3), wherein the malfunction determination threshold value determiner comprises a state-dependent appropriateness determiner configured to determine that at least one of the first adjustment air-pressure related value and the second adjustment air-pressure related value is not appropriate for the determination of the malfunction determination threshold value, when it is determined that the first state and the second state are identical to each other based on the first adjustment air-pressure related value and the second adjustment air-pressure related value.

The wordings “the first adjustment air-pressure related value and the second adjustment air-pressure related value are equal to each other” mean that these values are generally equal to each other and that an absolute value of a difference between the first adjustment air-pressure related value and the second adjustment air-pressure related value is less than or equal to a set value. The wordings “the first adjustment air-pressure related value and the second adjustment air-pressure related value differ from each other” mean that these values are not generally equal to each other. One example of this state is a case where the absolute value of the difference between these values is greater than the set value.

The wordings “the first state and the second state are identical to each other” mean the first state and the second state are generally identical to each other. Examples of this state include a case where an air pressure of the same wheel is generally the same in the first state and the second state and a case where a relative relationship in air pressure is the same in the first state and the second state.

(5) The air-pressure monitoring device according to any one of the above forms (1) through (4), comprising a plurality of wheel speed sensors provided respectively for the plurality of wheels and each configured to detect a rotational speed of a corresponding one of the plurality of wheels,

wherein the adjustment air-pressure related value acquirer comprises a wheel-speed-dependent adjustment air-pressure related value acquirer configured to acquire the adjustment air-pressure related value based on a value detected by at least one of the plurality of wheel speed sensors which corresponds to the at least one wheel.

Based on the values detected by the wheel speed sensors, the dynamic load radius as the air-pressure related value and the vibration characteristics (e.g., the resonant frequency) may be acquired.

(6) The air-pressure monitoring device according to any one of the above forms (1) through (5), wherein the adjustment air-pressure related value acquirer comprises a running acquirer configured to acquire the adjustment air-pressure related value when the adjusted information is output, and a running state of the vehicle is a set running state.

For example, the set running state may be set to a state in which a running speed of the vehicle is within a predetermined set range (a range in which it is possible to consider generally the same speed), and the vehicle is running generally straight (a state in which an absolute value of a steering angle or a rudder angle is smaller than or equal to a set value near zero). In this state, the rotation angle velocities of the respective four wheels are the same in the case where the dynamic load radiuses are the same.

The adjustment air-pressure related value may be acquired based on one detection value and may be acquired based on a plurality of detection values. For example, the adjustment air-pressure related value may be acquired by acquiring detection values of the wheel speed sensors during a predetermined set time in a period in which the running state of the vehicle is the set running state and by processing the acquired detection values. It is noted that the resonant frequency as the vibration characteristics is acquired by processing the detection values acquired during the set time (e.g., Fourier transform).

In each of the first state and the second state, the adjustment air-pressure related value is acquired in the set running state of the vehicle. In other words, the first adjustment air-pressure related value and the second adjustment air-pressure related value are preferably acquired in the same running state of the vehicle. This is because, as will be described below, in the case where a difference of the air-pressure related values due to change in air pressure is acquired based on the difference between the first adjustment air-pressure related value and the second adjustment air-pressure related value, there is a need that a change in the running state of the vehicle does not affect the air-pressure related value.

(7) The air-pressure monitoring device according to any one of the above forms (1) through (6), wherein the air-pressure monitoring device comprises a preset value determiner configured to determine a preset value as the malfunction determination threshold value when the malfunction determination threshold value determiner determines that the at least one of the first adjustment air-pressure related value and the second adjustment air-pressure related value is not appropriate for the determination of the malfunction determination threshold value.

The preset value is a malfunction determination threshold value determined in the case where genuine wheels (hereinafter may be referred to as “genuine tires”) are mounted on the vehicle. The dynamic load radius, the vibration characteristics, and other similar parameters of each genuine wheel are acquired beforehand, and the malfunction determination threshold value is determined in advance based on these values and stored. In the case where a rotation of the wheels is performed, the preset value may be used, but in the case where wheel replacement (hereinafter may be referred to as “tire replacement” because it is possible to consider the wheel includes the tire) is performed, a newly determined malfunction determination threshold value is preferably used.

As described above, however, the preset value is used in the case where the malfunction determination threshold value is not determined. This configuration can avoid a change or determination of the malfunction determination threshold value to an inappropriate value, thereby increasing robustness in the determination of the malfunction determination threshold value.

(8) The air-pressure monitoring device according to any one of the above forms (1) through (7), further comprising (i) an operation portion operable by an operator and (ii) an adjusted information creator configured to output the adjusted information in accordance with an operation for the operation portion.

For example, an operation pattern (a first pattern) of the operation portion after the adjustment to the first state and an operation pattern (a second pattern) of the operation portion after the adjustment to the second state are usually determined in advance, and the operator usually operates the operation portion under a predetermined rule in the first pattern or the second pattern. The first adjusted information is created and output in the case where the operation portion is operated in the first pattern, and the second adjusted information is created and output in the case where the operation portion is operated in the second pattern.

It is noted that the adjusted information may be created and output without operation by the operator.

(9) The air-pressure monitoring device according to any one of the above forms (1) through (8), further comprising:

a monitoring air-pressure related value acquirer configured to acquire a monitoring air-pressure related value as the air-pressure related value when monitoring the air pressure, the monitoring air-pressure related value being related to the air pressure of the at least one of the plurality of wheels; and

an air pressure monitor configured to monitor whether there is at least one wheel in which an air pressure in a tire is outside an appropriate range, among the plurality of wheels at least based on the malfunction determination threshold value and the monitoring air-pressure related value acquired by the monitoring air-pressure related value acquirer.

The monitoring air-pressure related value and the adjustment air-pressure related value may be obtained by different arithmetic expressions and may be obtained by the same arithmetic expression. Also, any of the same wheel or different wheels may be used as the wheel corresponding to the wheel speed used in the case where the adjustment air-pressure related value and the monitoring air-pressure related value are obtained. For example, these values may be obtained such that the monitoring air-pressure related value is obtained based on the wheel speeds of the respective four wheels, and the adjustment air-pressure related value may be obtained based on a rotational speed or speeds of one or some of the four wheels (e.g., two wheels).

It is noted that the monitoring air-pressure related value may be referred to as “object air-pressure related value”.

(10) The air-pressure monitoring device according to the above form (9), wherein the malfunction determination threshold value determiner comprises an interpolation-dependent determiner configured to determine the malfunction determination threshold value based on a difference between the first adjustment air-pressure related value and the second adjustment air-pressure related value and based on a reference air-pressure related value as the monitoring air-pressure related value which is a value in a case where air pressures in all tires of the plurality of wheels of the vehicle fall within a set range determined by a reference pressure.

Based on the reference air-pressure related value and the difference between the first adjustment air-pressure related value and the second adjustment air-pressure related value, it is possible to acquire a deviation between the reference air-pressure related value and an air-pressure related value based on which determination of a malfunction is possible (a monitoring air-pressure related value based on which it can be determined that there is at least one wheel in which air pressure in tire is outside the appropriate range among the plurality of wheels). The malfunction determination threshold value may be set at the deviation and may be set at a value determined by the deviation and the reference air-pressure related value.

The appropriate range is larger than the set range. The set range is a range in which it is possible to consider that each of the air pressures of the plurality of wheels is generally the reference pressure, and the appropriate range is a range in which it is possible to consider that the air pressure is normal (there is no malfunction).

Also, any one of the first state and the second state may be set at the reference state (a state in which the air pressures in all the tires of the plurality of wheels are within the set range determined by the reference pressure). In this case, the reference air-pressure related value can be acquired in any one of the first state and the second state.

(11) The air-pressure monitoring device according to the above form (9) or (10),

wherein the malfunction determination threshold value determiner comprises a deviation determiner configured to determine, as the malfunction determination threshold value, a deviation between the monitoring air-pressure related value based on which it is possible to determine that there is at least one wheel in which an air pressure in a tire is outside the appropriate range among the plurality of wheels and the reference air-pressure related value as the monitoring air-pressure related value which is a value in a case where air pressures in all tires of the plurality of wheels of the vehicle fall within a set range determined by a reference pressure, and

wherein the air pressure monitor comprises a deviation-dependent monitor configured to compare an absolute value of a difference between the monitoring air-pressure related value and the reference air-pressure related value with the deviation as the malfunction determination threshold value to monitor whether there is at least one wheel in which an air pressure in a tire is outside the appropriate range among the plurality of wheels.

(12) The air-pressure monitoring device according to any one of the above forms (9) through (11),

wherein the malfunction determination threshold value determiner comprises a reference-value-and-deviation determiner configured to determine, as the malfunction determination threshold value, a value determined by the reference air-pressure related value and a deviation between the monitoring air-pressure related value based on which it is possible to determine that there is at least one wheel in which an air pressure in a tire is outside the appropriate range among the plurality of wheels and a reference air-pressure related value as the monitoring air-pressure related value which is a value in a case where air pressures in all tires of the plurality of wheels of the vehicle fall within a set range determined by a reference pressure, and

wherein the air pressure monitor comprises a reference-value-and-deviation-dependent monitor configured to compare the monitoring air-pressure related value with a malfunction determination threshold value determined by the deviation and the reference air-pressure related value, to monitor whether there is at least one wheel in which an air pressure in a tire is outside the appropriate range among the plurality of wheels.

A malfunction determination threshold value αth may be set at any of (a) a value determined based on a reference air-pressure related value α1 and a deviation Δα {(αth=α1+Δα), (αth=α1−Δα)} and (b) a deviation (αth=Δα). In the case (a), the malfunction determination threshold value αth and a monitoring air-pressure related value α* are compared with each other. In the case (b), the malfunction determination threshold value αth and an absolute value of a difference between the monitoring air-pressure related value α* and the reference air-pressure related value α1 are compared with each other (αth: |α*−α1|).

(13) The air-pressure monitoring device according to any one of the above forms (10) through (12), wherein the malfunction determination threshold value determiner comprises a reference air-pressure related value acquirer configured to acquire and update the reference air-pressure related value based on reference value update information.

In the case where a rotation of the wheels is performed or in the case where the air pressures are adjusted, there is a low necessity of updating (changing) the malfunction determination threshold value, but the reference air-pressure related value is preferably updated (changed).

The operation portion may be determined in advance to be operated under a rule (a third pattern) after a rotation of the tire or an adjustment of the air pressures. In this case, when the operation portion is operated in the third pattern, the reference value update information is created and output.

In the case where the second state is the reference state, for example, the second pattern and the third pattern may be set to be the same as each other.

(14) The air-pressure monitoring device according to any one of the above forms (9) through (13),

wherein the adjustment air-pressure related value acquirer comprises a rotation angle velocity value acquirer configured to acquire a rotation angle velocity value as the adjustment air-pressure related value, and the rotation angle velocity value is determined by a rotation angle velocity of each of the at least one wheel,

wherein the monitoring air-pressure related value acquirer comprises a dynamic-load-radius related value acquirer configured to acquire a dynamic-load-radius related value as the monitoring air-pressure related value based on a rotation angle velocity of each of the plurality of wheels, and the dynamic-load-radius related value indicates a relationship between dynamic load radiuses of the plurality of wheels, and

wherein the malfunction determination threshold value determiner comprises a rotation-angle-velocity-difference-dependent appropriateness determiner configured to determine whether the determination of the malfunction determination threshold value is appropriate, based on a first rotation angle velocity value as the first adjustment air-pressure related value and a second rotation angle velocity value as the second adjustment air-pressure related value which are acquired by the rotation angle velocity value acquirer.

(15) The air-pressure monitoring device according to any one of the above forms (9) through (14),

wherein the monitoring air-pressure related value acquirer comprises a resonant frequency acquirer configured to acquire a resonant frequency of each of the at least one wheel as the monitoring air-pressure related value,

wherein the monitoring air-pressure related value acquirer comprises a resonant frequency acquirer configured to acquire a resonant frequency of each of the plurality of wheels as the monitoring air-pressure related value, and

wherein the malfunction determination threshold value determiner comprises a resonant-frequency-difference-dependent appropriateness determiner configured to determine whether the determination of the malfunction determination threshold value is appropriate, based on at least one of (a) a difference between resonant frequencies of an identical wheel, which are expected to differ from each other in air pressure in an tire, in the first state and the second state and (b) a difference between resonant frequencies of two wheels, which differ from each other in air pressure in an tire, in one of the first state and the second state.

(16) The air-pressure monitoring device according to any one of the above forms (1) through (15), wherein the malfunction determination threshold value determiner comprises a time-distance-dependent appropriateness determiner configured to determine that the at least one of the first adjustment air-pressure related value and the second adjustment air-pressure related value is not appropriate for the determination of the malfunction determination threshold value, in at least one of (a) a case where a time elapsed from a point in time when the first adjusted information is output to a point in time when the second adjusted information is output is greater than a predetermined set time and (b) a case where a travel distance of the vehicle from a point in time when the first adjusted information is output to a point in time when the second adjusted information is output is greater than a predetermined set distance.

In this case, reliability of an air pressure adjusting operation performed by the operator is low, and there is high possibility that the operation is inappropriate. Thus, it is determined that the at least one of the first adjustment air-pressure related value and the second adjustment air-pressure related value is not appropriate for the determination of the malfunction determination threshold value.

It is noted that a starting point of measurement of the elapsed time may be set at a point in time when the first adjustment air-pressure related value is acquired, and an end point of the measurement of the elapsed time may be set at a point in time when the second adjustment air-pressure related value is acquired.

(17) A malfunction-determination-threshold-value determination method of determining a malfunction determination threshold value in an air-pressure monitoring device configured to use the malfunction determination threshold value to monitor whether there is at least one wheel in which an air pressure is outside an appropriate range among a plurality of wheels provided on a vehicle, the malfunction-determination-threshold-value determination method comprises:

a first adjustment air-pressure related value acquiring step of acquiring a first adjustment air-pressure related value, as an air-pressure related value related to an air pressure of at least one of the plurality of wheels, based on first adjusted information indicating that a state of air pressures of the plurality of wheels has been adjusted to a predetermined first state;

a second adjustment air-pressure related value acquiring step of acquiring a second adjustment air-pressure related value, as an air-pressure related value related to the air pressure of the at least one of the plurality of wheels, based on second adjusted information indicating that the state of the air pressures of the plurality of wheels has been adjusted to a second state different from the first state;

an appropriateness determining step of determining whether at least one of the first adjustment air-pressure related value and the second adjustment air-pressure related value is appropriate for determination of the malfunction determination threshold value, based on the first adjustment air-pressure related value and the second adjustment air-pressure related value; and

an appropriate-state malfunction determination threshold value determining step of:

not executing the determination of the malfunction determination threshold value based on the at least one of the first adjustment air-pressure related value and the second adjustment air-pressure related value when it is determined in the appropriateness determining step that the at least one of the first adjustment air-pressure related value and the second adjustment air-pressure related value is not appropriate for the determination of the malfunction determination threshold value; and

executing the determination of the malfunction determination threshold value based on the at least one of the first adjustment air-pressure related value and the second adjustment air-pressure related value when it is determined in the appropriateness determining step that the the first adjustment air-pressure related value and the second adjustment air-pressure related value are appropriate for the determination of the malfunction determination threshold value.

The technical features according to any one of the above forms (1) through (16) may be employed for the malfunction-determination-threshold-value determination method according to this form.

### BRIEF DESCRIPTION OF THE DRAWINGS

FIG. 1 is a view schematically illustrating a vehicle including an air-pressure monitoring device according to Embodiment 1 of the present invention. A malfunction-determination-threshold-value determination method according to an embodiment of the present invention is implemented in the present air-pressure monitoring device.

FIG. 2 is a view illustrating a relationship between an air pressure and a resonant frequency.

FIG. 3 is a view illustrating a relationship among an air pressure, a rotation angle velocity, and a dynamic load radius.

FIG. 4 is a view illustrating a relationship between an air pressure and a dynamic-load-radius related value.

FIG. 5 is a flow chart illustrating an air pressure monitoring program stored in a storage device of a TPMSECU of the air-pressure monitoring device according to Embodiment 1.

FIG. 6 is a flow chart illustrating an air-pressure-state setting program stored in the storage device.

FIG. 7 is a flow chart illustrating a malfunction-determination-threshold-value determining program stored in the storage device.

FIG. 8 is a flow chart illustrating a reference-air-pressure-related-value acquiring program stored in the storage device.

FIG. 9 is a flow chart illustrating an air-pressure-state setting program stored in a storage device of an air-pressure monitoring device according to Embodiment 2 of the present invention.

FIG. 10 is a flow chart illustrating a portion of a malfunction-determination-threshold-value determining program stored in the storage device.

### EMBODIMENTS OF THE INVENTION

Hereinafter, there will be described an air-pressure monitoring device according to one embodiment of the present invention by reference to the drawings. The present air-pressure monitoring device uses malfunction determination threshold values to monitor whether or not there is at least one wheel having a tire whose air pressure is outside an appropriate range, among a plurality of wheels (noted that this monitoring may hereinafter referred to simply as “monitoring of air pressure”). The malfunction determination threshold values are determined by implementing a malfunction-determination-threshold-value determination method according to one embodiment of the present invention.

For wheels which are mounted on a vehicle in advance (i.e., genuine wheels), in most cases, air-pressure related values such as a dynamic load radius and a resonant frequency are acquired in advance, and malfunction determination threshold values are stored in advance (noted that the malfunction determination threshold value determined for the genuine wheel may be referred to as “preset value”). However, in the case where the genuine wheel is replaced with a wheel on which a studless tire is mounted, for example, values such as the air-pressure related value change, and accordingly malfunction determination threshold values are preferably determined (changed).

The malfunction determination threshold values are acquired based on at least one of a first adjustment air-pressure related value and a second adjustment air-pressure related value respectively acquired in a first state and a second state.

An operator adjusts air pressures in tires of respective front left and right and rear left and right wheels selectively to the first state (a two-wheel high pressure state) or the second state (a reference state). The reference state is a state in which each of the air pressures in all the tires of the respective front left and right and rear left and right wheels has been adjusted to a magnitude in a set range determined by a reference pressure (this magnitude is generally equal to the reference pressure). The two-wheel high pressure state is a state in which each of the air pressures in the respective tires of the front right wheel and the rear right wheel is adjusted to the magnitude in the set range determined by the reference pressure, and each of the air pressures in the respective tires of the front left wheel and the rear left wheel is adjusted to a magnitude higher than the reference pressure (may also be referred to “standard pressure”) by x % (e.g., 10%). In the first state and the second state, the first adjustment air-pressure related value and the second adjustment air-pressure related value are acquired, respectively. Since the second state is the reference state, a reference air-pressure related value is also acquired. The reference air-pressure related value may or may not be equal to the second adjustment air-pressure related value.

It is noted that each of the air pressures of the respective front left wheel and the rear left wheel may be higher than or lower than the reference pressure in the first state (the two-wheel high pressure state), but each air pressure is preferably higher than the reference pressure for the sake of running stability. Any of an air pressure of each of two wheels and an air pressure of one wheel or each of three wheels may be increased, but the air pressure of each of the two wheels is increased by x % more preferably for the sake of running stability than in the case where the air pressure of the one wheel is increased by 2x %. Also, in the case where the air pressure of each of the two wheels is increased, an air pressure of each of two wheels located respectively at diagonal positions may be increased, an air pressure of each of the right and left wheels may be increased, and an air pressure of each of the front and rear wheels may be increased, but these air pressures are preferably increased in a state in which lowering in running stability can be reduced.

It is not essential that the second state is the reference state. As long as the first state and the second state differ from each other, the reference air-pressure related value can be acquired according to interpolation, and each malfunction determination threshold value can be determined.

In the case where any one of the second state and the first state is set to the reference state, in contrast, the malfunction determination threshold value can be determined, and the reference air-pressure related value can be acquired directly.

Each malfunction determination threshold value can be determined to a value containing a deviation which is a difference between the reference air-pressure related value and a monitoring air-pressure related value which can be used to determine that there is one wheel in which an air pressure in a tire is lower than the appropriate range. For example, the malfunction determination threshold value may be the deviation and may be a value determined by the deviation and the reference air-pressure related value. In any case, the air pressure in the tire is determined to a magnitude which can be used to determine that the air pressure is lower than the appropriate range in the case where the air pressure is lower than the reference pressure by greater than or equal to k·x % of the reference pressure (e.g., k=2).

The monitoring air-pressure related value is acquired based on the air-pressure related value of at least one of the plurality of wheels. In the case where the malfunction determination threshold value is the deviation, the malfunction determination threshold value is compared with an absolute value of a difference between the monitoring air-pressure related value and the reference air-pressure related value, and in the case where the malfunction determination threshold value is a value determined by the deviation and the reference air-pressure related value, the monitoring air-pressure related value and the malfunction determination threshold value are compared with each other.

In the present embodiment, a malfunction determination threshold value fth based on the resonant frequency and a malfunction determination threshold value αth based on the dynamic load radius are determined, and both of the malfunction determination threshold values fth, αth are used to monitor the air pressure. However, it is not essential to use both of the malfunction determination threshold values, and any one of the malfunction determination threshold values can be used to monitor the air pressure.

The monitoring of the air pressures will be hereinafter explained.

### <Resonant Frequency>

### [Relationship Between Air Pressure and Resonant Frequency]

As illustrated in FIG. 2, an air pressure P in a tire of a wheel and a resonant frequency f have a relationship in which the resonant frequency f is larger in the case where the air pressure P is high than in the case where the air pressure P is low. Since a spring constant is larger in the case where the air pressure P is high than in the case where the air pressure P is low, the resonant frequency f increases.

The state of the air pressure can be acquired based on the resonant frequency as described above, making it possible to determine whether the air pressure falls within the appropriate range or not.

The first adjustment air-pressure related value corresponds to a first adjustment resonant frequency fᵢⱼ₀, and the second adjustment air-pressure related value corresponds to a second adjustment resonant frequency fᵢⱼ₁. The second adjustment resonant frequency is also the reference air-pressure related value. The monitoring air-pressure related value corresponds to a monitoring resonant frequency fij* (i=F, R, and j=R, L).

It is noted that the resonant frequency as the air-pressure related value is acquired for each of the front left and right and rear left and right wheels.

### [Determination of Malfunction Determination Threshold Values and Monitoring of Air Pressure]

### Determination of Malfunction Determination Threshold Value fth (=Δfi) and Monitoring of Air Pressure

(a) Each of the malfunction determination threshold values can be obtained based on a corresponding one of resonant frequencies (first adjustment resonant frequencies) f_{FL0}, f_{FR0}, f_{RL0}, f_{RR0} of the respective wheels which are acquired in the two-wheel high pressure state. A value obtained by subtracting a resonant frequency of the front right wheel in which an air pressure is equal to the reference pressure from a resonant frequency of the front left wheel in which an air pressure is higher than that of the front right wheel corresponds to an amount of change in resonant frequency which is established in the case where the air pressure has changed by x % of the reference pressure. By multiplying this obtained value by k, an amount of change in resonant frequency in the case where the air pressure has been changed by k·x % of the reference pressure can be obtained, and this amount of change in resonant frequency is set to a malfunction determination threshold value Δf_{F} for each of the front wheels.

Δf_{F}=k×(f_{FL}−f_{FR})

A malfunction determination threshold value Δf_{R} for each of the rear wheels is a value obtained by multiplying k by a value obtained by subtracting a resonant frequency of the rear right wheel in which an air pressure is equal to the reference pressure from a resonant frequency of the rear left wheel in which an air pressure is higher than that of the rear right wheel.

Δf_{R}=k×(f_{RL}−f_{RR})

In the case where a difference in resonant frequency between two wheels whose air pressures differ from each other is set to a deviation Δf in the first state (the two-wheel high pressure state) as described above, the malfunction determination threshold values can be determined without consideration of the second adjustment resonant frequency.
(b) The deviation Δf can also be obtained based on a difference between the resonant frequencies of the same wheel in the first state and the second state. In this case, the deviation Δf is obtained based on both of the first adjustment air-pressure related value and the second adjustment air-pressure related value.

Δf_{F}=k×(f_{FL0}−f_{FL1})

Δf_{R}=k×(f_{RL0}−f_{RL1})
(c) For each of the front left and right and rear left and right wheels, a value obtained by subtracting the monitoring resonant frequency fᵢⱼ* from a reference resonant frequency fᵢⱼ₁ is compared with a malfunction determination threshold value fthᵢ (fthᵢ=Δfᵢ). When the obtained value is larger than the malfunction determination threshold value, it is determined that the air pressure of the wheel is lower than the appropriate range.

(f_{Fj1}−f_{Fj}*)>fth_{F}

(f_{Rj1}−f_{Rj}*)>fth_{R}

(2) Determination of Malfunction Determination Threshold Value fth (=fᵢⱼ₁−Δfᵢ) and Monitoring of Air Pressure
(a) Resonant frequencies (the second adjustment resonant frequencies) f_{FL1}, f_{FR1}, f_{RL1}, f_{RR1} for the respective wheels which are acquired in the second state are used as the reference resonant frequency fᵢⱼ₁.

A malfunction determination threshold value fthᵢⱼ is determined for each of the wheels.

fth_{Fj}=f_{Fj1}−Δf_{F}

fth_{Rj}=f_{Rj1}−Δf_{R}
(b) The monitoring resonant frequency fᵢⱼ* is compared with the malfunction determination threshold value fthᵢⱼ for each of the front left and right and rear left and right wheels. When the monitoring resonant frequency is lower than the malfunction determination threshold value (fᵢⱼ*<fthᵢⱼ), it is determined that the air pressure of the wheel is lower than the appropriate range.

It is noted that the malfunction determination threshold values may be determined according to the following equations:

fth_{Fj1}=f_{Fj1}+Δf_{F}

fth_{Rj1}=f_{Rj1}+Δf_{R}

In this case, in the case where the monitoring resonant frequency is higher than the malfunction determination threshold value (fᵢⱼ*>fthᵢⱼ), it may be determined that the air pressure in the tire of the wheel is higher than the appropriate range. For example, a rise in temperature of the tire indicates that the air pressure in the tire of the wheel exceeds the appropriate range.

### <Dynamic Load Radius (Rotation Angle Velocity)>

### [Relationship Between Dynamic Load Radius and Air Pressure]

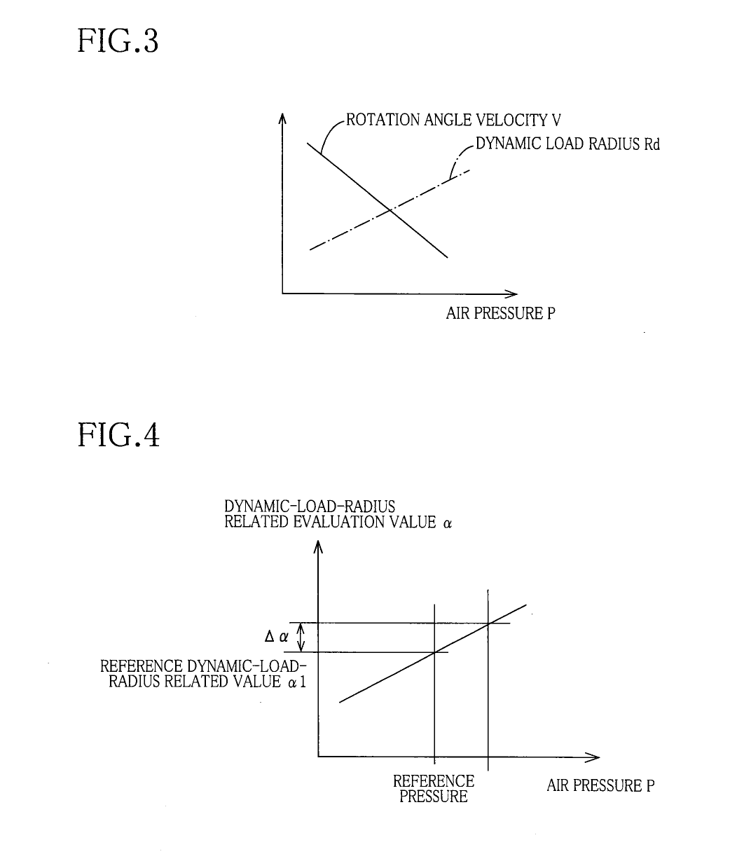

As illustrated in FIG. 3, the air pressure P of the wheel and a dynamic load radius Rd have a relationship in which the dynamic load radius Rd is greater in the case where the air pressure P is high than in the case where the air pressure P is low. This is because the diameter of the tire increases with increase in the air pressure P. In the case where the vehicle is running straight, a rotation angle velocity V of a wheel having a larger dynamic load radius Rd is less than that of a wheel having a smaller dynamic load radius Rd. Accordingly, the air pressure P and the rotation angle velocity V have a relationship in which the rotation angle velocity V is less in the case where the air pressure P is high than in the case where the air pressure P is low.

Thus, the state of the air pressure can be obtained based on the dynamic load radius Rd and the rotation angle velocity V, making it possible to determine whether the air pressure falls within the appropriate range.

A monitoring dynamic-load-radius related value α is used as the monitoring air-pressure related value. The dynamic-load-radius related value α is obtained by dividing the sum of rotation angle velocities of one pair of two wheels (e.g., the front right wheel and the rear left wheel) located at diagonal positions by the sum of rotation angle velocities of the other pair of two wheels (e.g., the front left wheel and the rear right wheel).

α=(V_{FR}+V_{RL})/(V_{FL}+V_{RR})

Since the dynamic-load-radius related value α is represented by a ratio between the sum of the rotation angle velocities of the one pair of two wheels located at the diagonal positions and the sum of the rotation angle velocities of the other pair of two wheels located at the other diagonal positions. Thus, in the case where dynamic load radiuses (air pressures) of the respective front left and right wheels are generally equal to each other, and dynamic load radiuses (air pressures) of the respective rear left and right wheels are generally equal to each other, in the case where the dynamic load radiuses of the respective left front and rear wheels are generally equal to each other, and the dynamic load radiuses of the respective right front and rear wheels are generally equal to each other, or in the case where the air pressures of the respective front left and right and rear left and right wheels are generally equal to each other, the dynamic-load-radius related value α is close to one, and a reference dynamic-load-radius related value α1 is close to one.

On the other hand, when an air pressure of one of the one pair of two wheels (the front right wheel and the rear left wheel) has lowered, and a rotation angle velocity of the one wheel has increased, the dynamic-load-radius related value α increases, and when an air pressure of one of the other pair of two wheels (the front left wheel and the rear right wheel) has lowered, and a rotation angle velocity of the one wheel has increased, the dynamic-load-radius related value α decreases.

In view of the above, the dynamic-load-radius related value α is a value which increases or decreases in the case where there is at least one wheel in which the air pressure in the tire is relatively low. Thus, it can be satisfactorily understood, based on the dynamic-load-radius related value α, whether there is at least one wheel in which the air pressure is lower than the appropriate range among the plurality of wheels.

In the case where the air pressures of the respective four wheels are generally equal to each other, the reference dynamic-load-radius related value α is close to one. Accordingly, the reference dynamic-load-radius related value α is little affected in the reference state by the magnitude of each of the air pressures of the respective four wheels. The reference dynamic-load-radius related value α is close to one also in the two-wheel high pressure state. Thus, even in case where the reference dynamic-load-radius related value α is erroneously acquired in the two-wheel high pressure state, the reference dynamic-load-radius related value α is close to one, thereby increasing robustness in determination of the malfunction determination threshold values, by using the dynamic-load-radius related value α.

Furthermore, since each of a rotation angle velocity of a turning-state outside wheel and a rotation angle velocity of a turning-state inside wheel is contained in the numerator and the denominator, the reference dynamic-load-radius related value α is close to one even during turning of the vehicle. Accordingly, even while the vehicle is turning, the reference dynamic-load-radius related value can be acquired.

It is noted that FIG. 4 illustrates a change in the case where an air pressure of one of the other pair of two wheels (the front left wheel and the rear right wheel) has decreased.

A rotation angle velocity of one wheel, the sum of rotation angle velocities of two or more wheels (which may be collectively referred to as “rotation angle velocity value”), and so on are used as the air-pressure related value. The first adjustment air-pressure related value corresponds to a first adjustment rotation angle velocity value (V_{RL0}, V_{FL0}, β01, β02, β0), and the second adjustment air-pressure related value corresponds to a second adjustment rotation angle velocity value (V_{RF1}, V_{FL1}, β11, β12, β1).

The first and second adjustment rotation angle velocity values β0, β1 are the sum of rotation angle velocities of the respective front left and right and rear left and right wheels. The first and second adjustment rotation angle velocity values β01, β11 are the sum of rotation angle velocities of the one pair of two wheels (the front right wheel and the rear left wheel) located at the diagonal positions. The first and second adjustment rotation angle velocity values β02, β12 are the sum of rotation angle velocities of the other pair of two wheels (the front left wheel and the rear right wheel) located at the diagonal positions.

β01=(V_{FR0}+V_{RL0})

β02=(V_{FL0}+V_{RR0})

β11=(V_{FR1}+V_{RL1})

β12=(V_{FL1}+V_{RR1})

β0=β01+β02

β1=β11+β12

### [Determination of Malfunction Determination Threshold Values and Monitoring of Air Pressure]

### (1) Determination of Malfunction Determination Threshold Value αth (=Δα) and Monitoring of Air Pressure

(a) The malfunction determination threshold value αth (=Δα) is obtained by dividing, by the second adjustment rotation angle velocity value β12 (the denominator of the reference dynamic-load-radius related value), the sum {(β01−β11)+(β02−β12)} of values (β01−β11), (β02−β12) which are obtained by subtracting the second adjustment rotation angle velocity values β11, β12 from the first adjustment rotation angle velocity values β01, β02, respectively.

$$\begin{matrix}Δα = ( β 0 - β 1 ) \text{/} β 12 \\ = \{ ( β 01 - β 11 ) + ( β 02 - β 12 ) \} \text{/} β 12\end{matrix}$$

The value (β0−β1) obtained by subtracting the second adjustment rotation angle velocity value β1 from the first adjustment rotation angle velocity value β0 is a difference in rotation angle velocity between the case where the air pressure in each of the tires of the respective two wheels is higher than the reference pressure by x % and the case where the air pressure in each of the tires of the respective two wheels is equal to the reference pressure. The value (β0−β1) corresponds to a difference in rotation angle velocity between the case where the air pressure in the tire of the one wheel is higher than the reference pressure by 2x % and the case where the air pressure in the tire of the one wheel is equal to the reference pressure. According to the interpolation, it is possible to acquire a difference in rotation angle velocity value between the case where the air pressure of the one wheel is equal to the reference pressure and the case where the air pressure of the one wheel is lower than the reference pressure by 2x %. In the case where it is determined that the air pressure falls outside the appropriate range when the air pressure has lowered to a value lower than the reference pressure by 2x %, a deviation Δα is set at a value determined by dividing the difference between the second adjustment rotation angle velocity value β1 and the first adjustment rotation angle velocity value β0 by the denominator (V_{FL1}+V_{RR1}) of the reference dynamic-load-radius related value α1.

In general, in the case where it is determined that there is a malfunction if the air pressure has decreased by k·x %, the malfunction determination threshold value αth can be determined as in the following equation:

αth=Δα×k/2
(b) In the case where the air pressure is monitored, an absolute value of a difference between a monitoring dynamic-load-radius related value α* and the reference dynamic-load-radius related value α1 is compared with a malfunction determination threshold value Δα, and when the absolute value of the difference is larger than the malfunction determination threshold value, it is determined that an air pressure in a tire of at least one of the four wheels is lower than the appropriate range.

|αij*−α1|>αth(Δα)

Determination of Malfunction Determination Threshold Value αth (=α1+Δα, α1−Δα) and Monitoring of Air Pressure

αthx=α1+Δα

αthy=α1+Δα

In this case, the monitoring dynamic-load-radius related value α* and the malfunction determination threshold value αth are compared with each other, and when the monitoring dynamic-load-radius related value α* is larger than a malfunction determination threshold value αthx or smaller than a malfunction determination threshold value αthy, it is determined that there is at least one wheel in which an air pressure is lower than the appropriate range, among the four wheels.

α*>αthx or α*<αthy

In the case where the determination is thus based on the dynamic load radius, it is not identified which wheel is the wheel in which the air pressure in the tire is outside the appropriate range.

### <Appropriateness of Determination of Malfunction Determination Threshold Values>

As described above, the adjustment of the air pressure to the first state and the second state is performed by the operator.

After tire replacement, the operator adjusts the air pressures in the tires of the respective four wheels to the first state (the two-wheel high pressure state) and then to the second state (the reference state). After adjusting the air pressures to the first state and the second state, the operator has to perform operations under a predetermined rule (a pattern). Specifically, the operation pattern is determined by the length of an ON operation of a reset switch (RstSW). The ON time after the air pressures are adjusted to the first state is defined as T1, e.g., five seconds (a first pattern), and the ON time after the air pressures are adjusted to the second state is defined as T2, e.g., three seconds (a second pattern). In the operations performed by the operator according to the pattern of the reset switch, it is determined that the state of the air pressures of the respective four wheels is adjusted to the two-wheel high pressure state and the reference state, and first adjusted information and second adjusted information are created and output.

In some cases, however, the air pressure adjusting operation may not be appropriately performed (under the rule) due to an error of the operator, and the switch operation may be performed without the adjustment of the air pressures.

In case where the adjustment of the air pressures and the switch operation are not performed under the rule, the malfunction determination threshold value becomes an inappropriate value in some cases. For example, in the case where the first state and the second state are the same as each other, the first adjustment rotation angle velocity value β0 and the second adjustment rotation angle velocity value β1 are generally equal to each other (β0≈β1). However, when it is estimated that the difference between the first and second adjustment rotation angle velocity values β0, β1 is the difference in the case where the air pressure in the tire of the one wheel is higher than the reference pressure by 2x %, the malfunction determination threshold value is determined to an inappropriate value, resulting in the case where it cannot be appropriately determined whether the air pressure falls within the appropriate range or not.

To solve this problem, in the present embodiment, the first and second adjustment air-pressure related values acquired in the respective first and second states are compared with each other, and when the first and second adjustment air-pressure related values are generally equal to each other, the first state and the second state are estimated to be generally the same state, and it is determined that at least one of the first adjustment air-pressure related value and the second adjustment air-pressure related value is not appropriate for the determination of the malfunction determination threshold values. The determination of the malfunction determination threshold values is not performed, and the preset value is used.

### Embodiment 1

### <Structure>

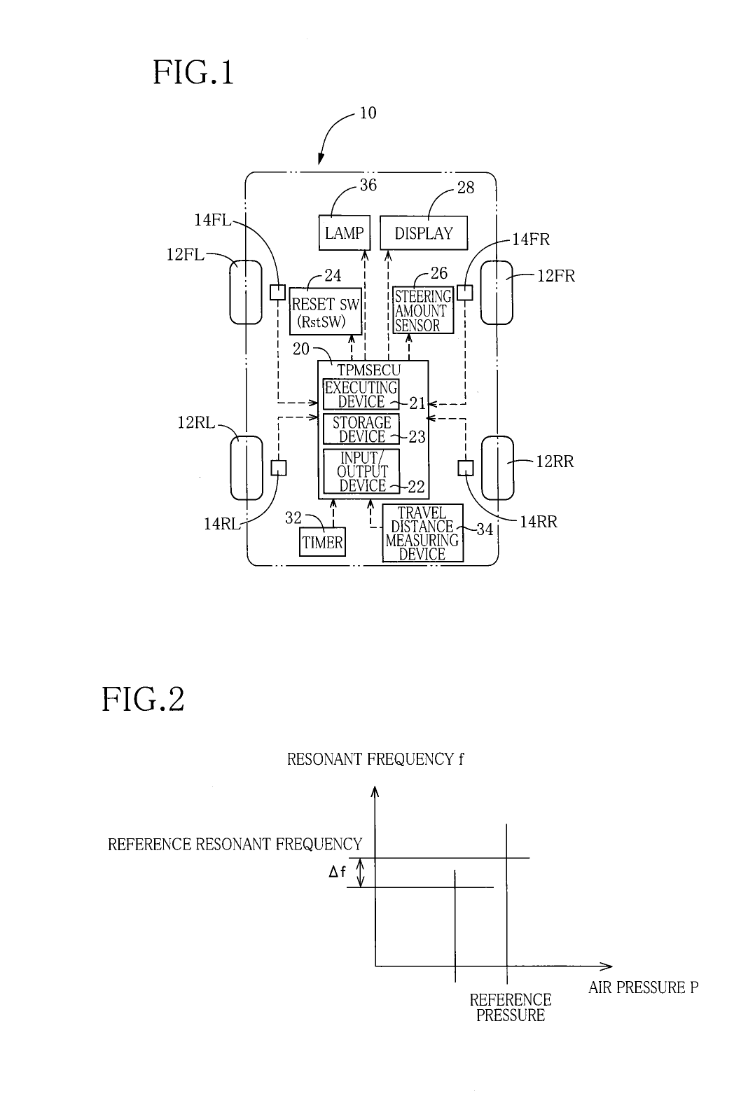

As illustrated in FIG. 1, a vehicle 10 is provided with front left and right and rear left and right wheels 12FL, FR, RL, RR and wheel speed sensors 14FL, FR, RL, RR respectively corresponding to the wheels 12FL, FR, RL, RR and each configured to detect a rotation angle velocity of a corresponding one of the wheels. The vehicle 10 includes a TPMSECU 20 mainly constituted by a computer. The TPMSECU 20 includes an executing device 21, an input/output device 22, and a storage device 23. Devices connected to the input/output device 22 include the wheel speed sensors 14FL, FR, RL, RR, a reset switch (RstSW) 24, a steering amount sensor 26, a display 28, a timer 32, and a travel distance measuring device 34. In the following description, in the case where distinction of the wheels is not required, or components for the respective wheels are collectively referred, for example, suffixes (FL, FR, RL, RR) indicative of the corresponding wheels may be omitted (e.g., the wheels 12 and the wheel speed sensors 14).

The reset switch 24 is operable by, e.g., an operator or a driver and determined to be operated for instructing acquisition of the first adjustment air-pressure related value and the second adjustment air-pressure related value (in the case where the air pressures in the tires of the respective four wheels 12FL, FR, RL, RR are adjusted) or for instructing acquisition of the reference air-pressure related value (in the case where a rotation of the wheels is performed or in the case where the air pressures in the respective tires are adjusted). Operation patterns are determined in advance according to the instructions.

The steering amount sensor 26 detects a steering angle of a steering wheel, not shown. It is determined that the vehicle is running straight when an absolute value of the steering angle detected by the steering amount sensor 26 is smaller than or equal to a set value.

The display 28 can display various kinds of information including: information indicating that an air pressure of at least one of the front left and right and rear left and right wheels 12FL, FR, RL, RR falls within the appropriate range; and information indicating that an air pressure of at least one of the front left and right and rear left and right wheels 12FL, FR, RL, RR is lower than the appropriate range.

The timer 32 measures a length of time. In the present embodiment, the timer 32 measures a length of time extending from a point in time when the first adjusted information is output to a point in time when the second adjusted information is output.

The travel distance measuring device 34 measures a distance of travel of the vehicle and also measures a cumulative travel distance from a predetermined point in time. Based on a cumulative travel distance at a point in time when the first adjusted information is output and a cumulative travel distance at a point in time when the second adjusted information is output, it is possible to acquire a travel distance of the vehicle from the point in time when the first adjusted information is output to the point in time when the second adjusted information is output.

A lamp 36 blinks based on the operation of the reset switch 24. Also, the lamp 36 may be configured to blink in the case where there is a wheel in which an air pressure is lower than the appropriate range, in the case where the first adjustment air-pressure related value and the second adjustment air-pressure related value are acquired, or in the case where the malfunction determination threshold values are determined, for example.

Each of the wheel speed sensors 14FL, FR, RL, RR is an electromagnetic pickup sensor which acquires a rotation angle velocity by detecting a rotational position of a corresponding one of the wheels based on a change in electrical properties due to rotation of the wheel. Also, a running speed of the vehicle is acquired based on, e.g., an average of values detected by each of the wheel speed sensors 14FL, FR, RL, RR. Based on an average radius and a rotation angle velocity of each of the wheels 12FL, FR, RL, RR, a rotation circumferential velocity of the wheel can be acquired, and accordingly the running speed of the vehicle can be acquired. The radius used for acquiring the running speed is an average value which is considered not to be easily affected by the air pressure.

The storage device 23 stores a plurality of programs for monitoring the air pressures, for example.

Instead of the wheel speed sensors 14, a sensor for detecting a rotational speed of a propeller shaft may be provided to acquire the running speed based on the rotational speed of the propeller shaft, and a ground vehicle speed sensor (e.g., a Doppler sensor) may be provided to acquire the running speed.

Both of the lamp 36 and the display 28 are not necessarily provided as a notifying device as long as one of the lamp 36 and the display 28 is provided.

It is possible to consider that the reset switch 24 is included in the display 28 (in the case where the display 28 is constituted by a touch panel, it is possible to consider that the reset switch 24 is constituted by a portion of the display 28).

### <Monitoring of Air Pressure>

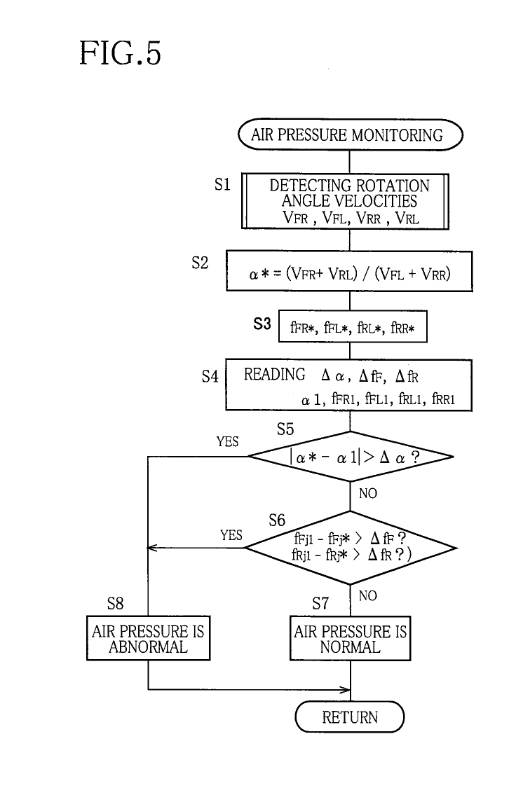

An air pressure monitoring program illustrated in the flow chart in FIG. 5 is executed when a predetermined air-pressure monitoring timing is reached. For example, the air pressure monitoring program may be executed each time when a predetermined set time period is elapsed (that is, the air-pressure monitoring timing is reached) during running of the vehicle, or the air pressure monitoring program may be executed in the case where the monitoring of the air pressures is requested, for example.

At Step 1 (hereinafter, “Step” is omitted where appropriate), a rotation angle velocity of each of the front left and right and rear left and right wheels 12FL, FR, RL, RR is acquired. In the present embodiment, values detected by the respective wheel speed sensors 14FL, FR, RL, RR are acquired within the predetermined set time period. Though the running state of the vehicle in the case where the rotation angle velocity is acquired may be any state, the values are preferably acquired in a state in which relatively large braking skid or driving skid does not occur on at least one wheel, for example.

At S2, the monitoring dynamic-load-radius related value α* is acquired based on the rotation angle velocities V_{FR}, V_{FL}, V_{RR}, V_{RL} acquired at S1. For example, the monitoring dynamic-load-radius related value α* is acquired based on an average of rotation angle velocities acquired within the set time period (a predetermined number of the acquired rotation angle velocities).

α*=(V_{FR}+V_{RL})/(V_{FL}+V_{RR})

At S3, the monitoring resonant frequency fᵢⱼ* for each wheel is acquired based on a plurality of sets of data on the acquired rotation angle velocities (i=F, R, j=R, L).

At S4, the malfunction determination threshold values Δα, Δf_{F}, Δf_{R}, the reference dynamic-load-radius related value α1, and the reference resonant frequency fᵢⱼ₁ are read. At S5, an absolute value of a difference between the monitoring dynamic-load-radius related value α* acquired at S2 and the reference dynamic-load-radius related value α1 acquired at S4 is compared with the malfunction determination threshold value Δα.

|α*−α1|>Δα

In the case where the absolute value of the difference is greater than the malfunction determination threshold value Δα, it is determined that there is high possibility that the four wheels 12FL, FR, RL, RR include at least one wheel in which an air pressure is low. In the case where the absolute value of the difference is smaller than or equal to the malfunction determination threshold value Δα, it is determined that there is low possibility that the four wheels 12FL, FR, RL, RR include at least one wheel in which an air pressure is low.

At S6, a value obtained by subtracting the monitoring resonant frequency fᵢⱼ* acquired at S3 for each of the front left and right and rear left and right wheels 12FL, FR, RL, RR from the reference resonant frequency fᵢⱼ₁ acquired at S4 is compared with the malfunction determination threshold value Δf_{F} for the front wheels and with the malfunction determination threshold value Δf_{R} for the rear wheels.

f_{Fj1}−f_{Fj}*>Δf_{F}

f_{Rj1}−f_{Rj}*>Δf_{R}

When the value obtained by subtracting the monitoring resonant frequency fᵢⱼ* from the reference resonant frequency fᵢⱼ₁ is smaller than or equal to a malfunction determination threshold value Δfᵢ, it is determined that there is high possibility that the air pressure of the wheel falls within the appropriate range, and when the value is larger than the malfunction determination threshold value Δfᵢ, it is determined that there is high possibility that the air pressure of the wheel is lower than the appropriate range.

When negative decisions (NO) are made at S5 and S6, that is, when it is determined that there is high possibility that each of the air pressures in all the tires of the respective four wheels 12FL, FR, RL, RR falls within the appropriate range in the case where the malfunction determination threshold values are based on the dynamic load radius and in the case where the malfunction determination threshold values are based on the resonant frequency, it is determined at S7 that each of the air pressures of the respective four wheels 12FL, FR, RL, RR is normal, and a notification is provided for this determination. This determination may be displayed on the display 28.

On the other hand, when a positive decision (YES) is made at S5 or S6, that is, when it is determined that there is high possibility that there is at least one wheel in which an air pressure is low in one of the case where the malfunction determination threshold values are based on the dynamic load radius and the case where the malfunction determination threshold values are based on the resonant frequency, it is determined at S8 that each of the air pressures of the respective four wheels 12FL, FR, RL, RR is not normal. A notification (alarm) is provided for this determination. For example, this determination may be displayed on the display 28, or the lamp 36 may be operated so as to blink.

It is noted that when a positive decision (YES) is made at S6, the wheel(s) in which the air pressure is low can be identified, and accordingly the position of the wheel(s) may be displayed on the display 28, for example.

It is not essential that the monitoring of the air pressures is performed based on both of the dynamic load radius and the resonant frequency, and the monitoring of the air pressures may be performed based on one of the dynamic load radius and the resonant frequency.

It may be determined whether the vehicle is running or not before S1.

### <Determination of Malfunction Determination Threshold Values>

### [Setting of Air Pressure State]

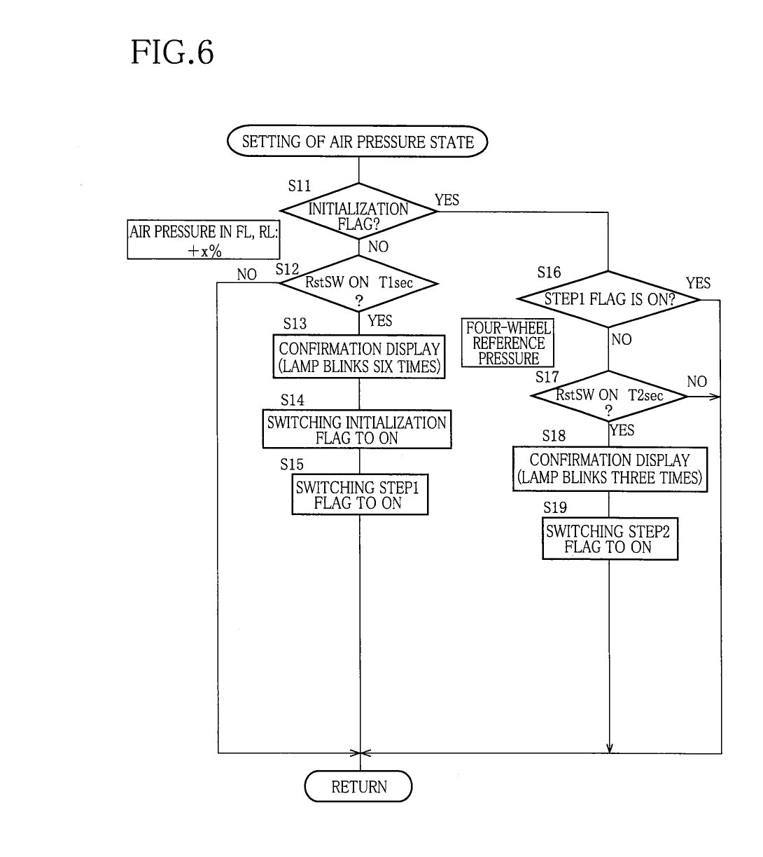

The operator adjusts the air pressure state of the front left and right and rear left and right wheels 12FL, FR, RL, RR to the two-wheel high pressure state and the reference state, and after this adjustment of the air pressure, the operator operates the reset switch 24 according to the predetermined pattern. The first adjusted information and the second adjusted information are created according to the operation pattern and output. This setting of the air pressure state is executed according to an air-pressure-state setting program illustrated in the flow chart in FIG. 6.

At S11, it is determined whether an initialization flag is ON or not. The initialization flag is switched to ON when the determination of the malfunction determination threshold values is instructed (acquisition of the first adjustment air-pressure related value is instructed). The initialization flag is switched to OFF when the first adjustment air-pressure related value and the second adjustment air-pressure related value are acquired. When the initialization flag is OFF, it is determined at S12 whether the reset switch 24 has been operated according to the first pattern or not. When the reset switch 24 is operated according to the first pattern, the adjustment to the two-wheel high pressure state is notified at S13. In the present embodiment, the lamp 36 blinks six times. At S14 and S15, the initialization flag is switched to ON, and a step1 flag is switched to ON.

In the present embodiment, the step1 flag corresponds to the first adjusted information, and when the step1 flag is switched to ON, the first adjustment air-pressure related value is acquired.

Since the air pressures are usually adjusted at rest of the vehicle, the operation of the reset switch 24 at S12 is also performed at rest of the vehicle in most cases, but the operation of the reset switch 24 is in some cases performed during running of the vehicle after the adjustment of the air pressures.

When this program is executed next, each of the initialization flag and the step1 flag is ON, and accordingly positive decisions (YES) are made at S11 and S16. When the first adjustment air-pressure related values β01, β02, fᵢⱼ₀ are acquired soon in the two-wheel high pressure state, the step1 flag is switched to OFF at S27. A negative decision (NO) is made at S16, and it is determined at S17 whether the operation according to the second pattern has been performed or not. When the operation according to the second pattern is performed, a positive decision (YES) is made at S17, and information that the air pressures have been adjusted to the reference state is indicated at S18 (the lamp 36 blinks three times). At S19, the step2 flag is switched to ON.

In the present embodiment, the step2 flag corresponds to the second adjusted information, and the second adjustment air-pressure related value is acquired based on the ON state of the step2 flag.

### [Determination of Malfunction Determination Threshold Values]

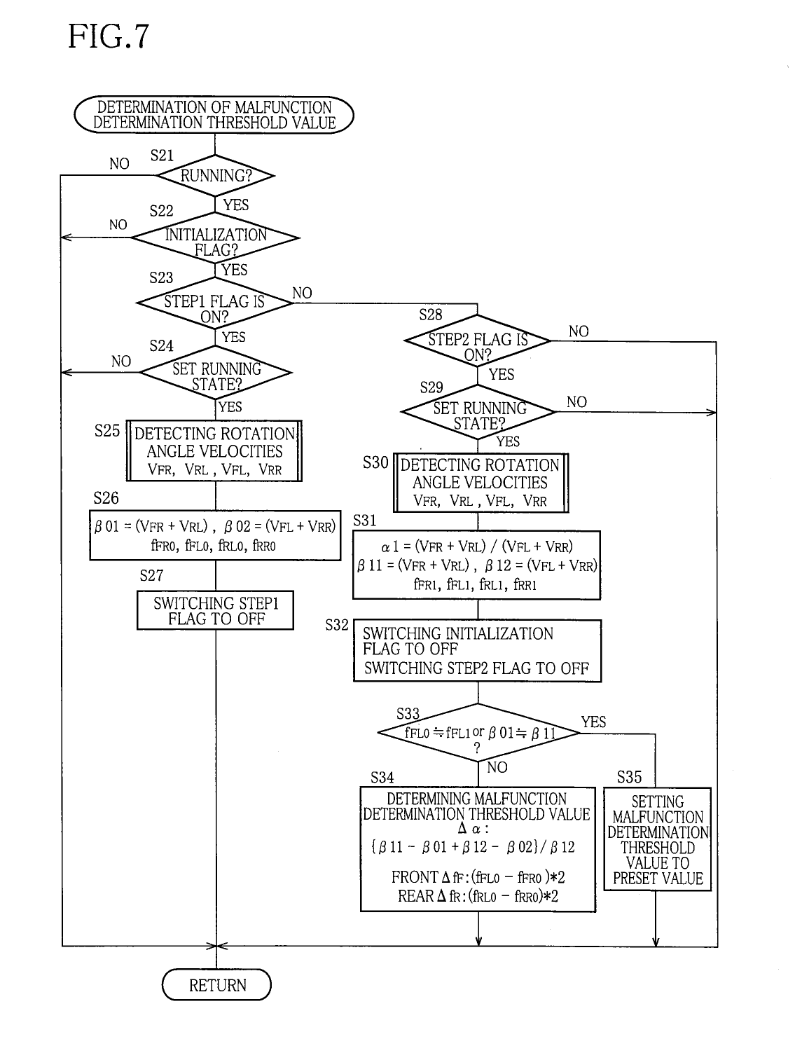

The malfunction determination threshold values are determined according to a malfunction-determination-threshold-value determining program illustrated in the flow chart in FIG. 7. While the air-pressure related values are acquired during running of the vehicle, the adjustment of the air pressures is in some cases performed in a state in which the vehicle is at rest, and an ignition switch is OFF. Also, the vehicle does not always start running immediately after the air pressures are set to the two-wheel high pressure state and the reference state. Thus, various flags and various acquired values such as the air-pressure related values are stored such that these parameters do not disappear even when the ignition switch is switched to OFF.

At S21, it is determined whether the vehicle is running or not. When the vehicle is running, it is determined at S22 whether the initialization flag is ON or not, and it is determined at S23 whether the step1 flag is ON or not. When both of the flags are ON, the first adjustment air-pressure related value is acquired.

At S24, it is determined whether the running state of the vehicle is a predetermined set running state or not. That is, it is determined whether or not the running state of the vehicle is a state which is appropriate for acquiring the air-pressure related values. In the present embodiment, the set running state is a state in which the running speed falls within a set speed range determined by a reference speed, and various conditions are satisfied such as a condition in which the vehicle is running generally straight. When the running state of the vehicle is not the set running state, a negative decision (NO) is made at S24, and the rotation angle velocity is not detected.

When the running state of the vehicle is the set running state, the rotation angle velocities V_{FL}, V_{FR}, V_{RL}, V_{RR} for the respective four wheels 12 are at S25 detected within the predetermined set time period. At S26, the first adjustment rotation angle velocity values β01, β02 and the first adjustment resonant frequency fᵢⱼ₀ are acquired. At S27, the step1 flag is switched to OFF.

In the case where the step1 flag is switched to OFF, the acquisition of the first adjustment air-pressure related value may be notified. For example, the lamp 36 may blink, and the acquisition may be displayed on the display 28.

Thereafter, the air pressures are expected to be adjusted, and the reference state (the second state) is expected to be established. When the reset switch 24 is operated according to the second pattern, the step2 flag is at S19 switched to ON. During running of the vehicle, positive decisions (YES) are made at S21 and S22, a negative decision (NO) is made at S23, and a positive decision (YES) is made at S28. When the running state of the vehicle is the set running state as at S24, a positive decision (YES) is made at S29, and this flow goes to S30 and S31. At S30, the rotation angle velocities for the respective four wheels 12FL, FR, RL, RR are acquired within the set time period. At S31, the second adjustment rotation angle velocity values β11, β12, the reference dynamic-load-radius related value α1, and the reference resonant frequency fᵢⱼ₁ are acquired.

In the case where the malfunction determination threshold values are determined, a difference between the first adjustment rotation angle velocity values β01, β02 and the second adjustment rotation angle velocity values β11, β12 is acquired, and a rotation angle velocity difference due to a change in air pressure is acquired. Thus, each of the rotation angle velocity values is preferably acquired in the same running state of the vehicle.

At S32, the initialization flag and the step2 flag are switched to OFF. The reference dynamic-load-radius related value and the reference resonant frequency are used in the monitoring of the air pressures as described above and accordingly stored.

At S33, appropriateness for the determination of the malfunction determination threshold values is judged.

For example, (i) in the case where the air pressures are adjusted appropriately in each of the two-wheel high pressure state and the reference state, the first adjustment rotation angle velocity values V_{FL0}, V_{RL0}, β01, β02, β0 and the second adjustment rotation angle velocity values V_{FL1}, V_{RL1}, β11, β12, β1 are different from each other, but in the case where the air pressures are not adjusted appropriately, for example, the first adjustment rotation angle velocity values V_{FL0}, V_{RL0}, β01, β02, β0 and the second adjustment rotation angle velocity values V_{FL1}, V_{RL1}, β11, β12, β1 may be generally equal to each other.

β01≈β11 (1)

β02≈β12 (2)

β0≈β1 (3)

V_{FL0}≈V_{FL1} (4)

V_{RL0}≈V_{RL1} (5)

Also, (ii) in the case where the air pressures are not adjusted appropriately, the first adjustment resonant frequencies f_{FL0}, f_{RL0} and the second adjustment resonant frequencies f_{FL1}, f_{RL1} for the front left wheel 12FL and the rear left wheel 12RL may be generally equal to each other.

f_{FL0}≈f_{FL1} (6)

f_{RL0}≈f_{RL1} (7)

Accordingly, in the case where any of the above-described conditions (1) through (7) is not satisfied, it is determined that the first adjustment air-pressure related value and the second adjustment air-pressure related value are appropriate for the determination of the malfunction determination threshold value, and at S34 each, malfunction determination threshold value is determined (Δα, Δf_{F}, Δf_{R}). In the case where one or more of the above-described conditions (1) through (7) are satisfied, it is determined that at least one of the first adjustment air-pressure related value and the second adjustment air-pressure related value is not appropriate for the determination of the malfunction determination threshold value, and at S35 the malfunction determination threshold value is set to the preset value.

### [Determination of Reference Air-Pressure Related Value]

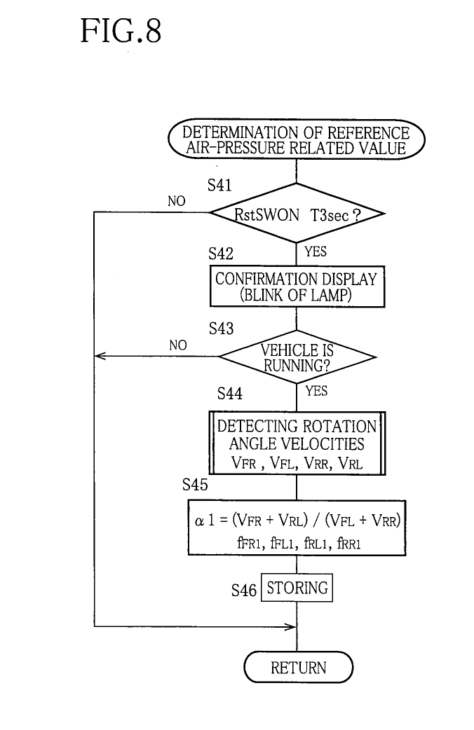

The reference air-pressure related value is preferably adjusted not only in the case where the wheel replacement has been performed but also in the case where the rotation of the wheels has been performed and in the case where the air pressures in the tires have been adjusted. This is because the reference air-pressure related value has changed in the case where the rotation has been performed and in the case where the air pressures have been adjusted, for example. A reference-air-pressure-related-value determining program illustrated in a flow chart in FIG. 8 is executed each time when a predetermined set time period is elapsed.

At S41, it is determined whether the reset switch 24 has been operated according to a third pattern or not. In the present embodiment, it is determined that the ON operation of the reset switch 24 has been performed for T3 seconds (e.g., three seconds) or not. The time T3 has the same length as the time T2, and the operation according to the third pattern is the same as the operation performed in the case where the air pressures have been adjusted to the reference state (in the case where the acquisition of the second adjustment air-pressure related value is instructed) (the third pattern=the second pattern). That is, in the case where the initialization flag is ON, the reference air-pressure related value is acquired in the determination of the malfunction determination threshold values, but even in the case where the initialization flag is OFF, the acquisition of the reference air-pressure related value may be instructed independently of the determination of the malfunction determination threshold values.

When the reset switch 24 is operated according to the third pattern, confirmation display is performed at S42 (for example, the lamp 36 blinks three times). At S43, it is determined whether the vehicle is running or not. When the vehicle is running, the rotation angle velocities at S44 are acquired within a set time period. At S45 and S46, the reference dynamic-load-radius related value α1 and the reference resonant frequency fᵢⱼ₁ are acquired each as the reference air-pressure related value and stored (updated). These values are stored by being replaced with the reference dynamic-load-radius related value and the reference resonant frequency stored at this point in time.

It is noted that when acquiring the reference air-pressure related value, the vehicle may not run in the set running state, but the processing at S44 may be executed in the case where the vehicle is running in the set running state.

In the present embodiment as described above, the air pressures are adjusted in both of the first state and the second state, and the malfunction determination threshold values are determined based on the adjustment air-pressure related values respectively acquired in the first state and the second state, and when at least one of the first adjustment air-pressure related value and the second adjustment air-pressure related value is not appropriate for the determination of the malfunction determination threshold values, the malfunction determination threshold values are not determined (corrected or updated) based on the at least one of the first adjustment air-pressure related value and the second adjustment air-pressure related value.

For example, each malfunction determination threshold value is avoided from being determined to an inappropriate value and set to the preset value in the case where the reset switch 24 has been operated according to the first pattern without adjustment of the air pressures to the two-wheel high pressure state by the operator, or in the case where the reset switch 24 has been operated according to the second pattern without adjustment of the air pressures to the reference state, for example. This configuration can increase the robustness in the determination of the malfunction determination threshold values.

Also, this configuration can reliably prevent monitoring of the air pressures using an inappropriate malfunction determination threshold value.

In the present embodiment, an adjustment air-pressure related value acquirer is constituted by, e.g., portions of the TPMSECU 20 which store and execute the processings at S25, S26, S30, and S31 of the malfunction-determination-threshold-value determining program. An air pressure monitor is constituted by, e.g., portions of the TPMSECU 20 which store and execute the air pressure monitoring program. Each of a malfunction determination threshold value determiner and an interpolation-dependent determiner is constituted by, e.g., portions of the TPMSECU 20 which store and execute the malfunction-determination-threshold-value determining program. Each of a comparison appropriateness determiner and a related-value-difference-dependent appropriateness determiner is constituted by, e.g., portions of the TPMSECU 20 which store and execute the processing at S33 of the malfunction-determination-threshold-value determining program. A preset value determiner is constituted by, e.g., portions of the TPMSECU 20 which store and execute the processing at S35 of the malfunction-determination-threshold-value determining program. A reference air-pressure related value acquirer is constituted by portions of the TPMSECU 20 which store and execute the reference-air-pressure-related-value determining program and the processings at S30 and S31 of the malfunction-determination-threshold-value determining program.

It is noted that the execution of the processings at, e.g., S25 and S26 corresponds to a first adjustment air-pressure related value acquiring step, the execution of the processings at, e.g., S30 and S31 corresponds to a second adjustment air-pressure related value acquiring step, the execution of the processing at, e.g., S33 corresponds to an appropriateness determining step, and the execution of the processing at, e.g., S34 corresponds to an appropriate-state malfunction determination threshold value determining step.

Among the first adjustment rotation angle velocity values V_{FL0}, V_{RL0}, β01, β02, β0 and the second adjustment rotation angle velocity values V_{FL1}, V_{RL1}, β11, β12, β1, each of the values β01, β02, β0 used for both of the determination of the malfunction determination threshold values and the judgment of appropriateness of the determination may be referred to as the first adjustment rotation angle velocity value, and each of the values β11, β12, β1 may be referred to as the second adjustment rotation angle velocity value. Furthermore, each of the values V_{FL0}, V_{RL0}, β01, β02, β0 used for at least one of the determination of the malfunction determination threshold values and the judgment of appropriateness of the determination may be referred to as the first adjustment rotation angle velocity value, and each of the values V_{FL1}, V_{RL1}, β11, β12, β1 may be referred to as the second adjustment rotation angle velocity value. Also, each of the rotation angle velocities (V_{FL}, V_{FR}, V_{RL}, V_{RR}) for the respective wheels are also used for acquiring the values β01, β11 and so on and accordingly can be considered to be the first and second adjustment rotation angle velocity values.

### Embodiment 2

In the present embodiment, in the case where a length of time between the point in time when the air pressures have been adjusted to the two-wheel high pressure state and the point in time when the air pressures have been adjusted to the reference state is longer than a set time Tth, it is considered that the reliability of operation performed by the operator is low. In this case, it is determined that at least one of the first adjustment air-pressure related value and the second adjustment air-pressure related value is not appropriate for the determination of the malfunction determination threshold values, and the preset value is at S35 determined as the malfunction determination threshold value.

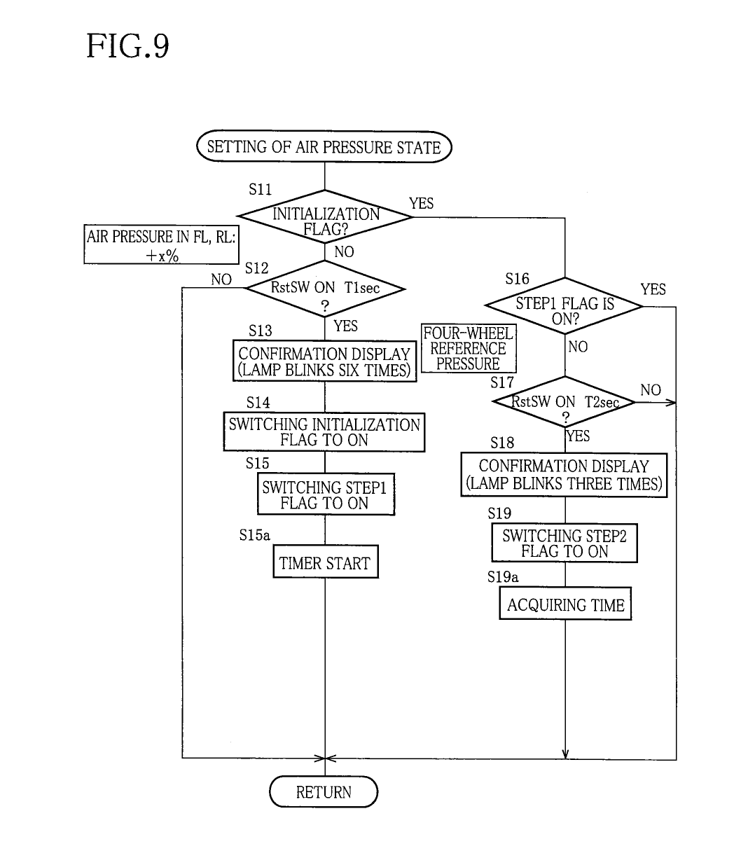

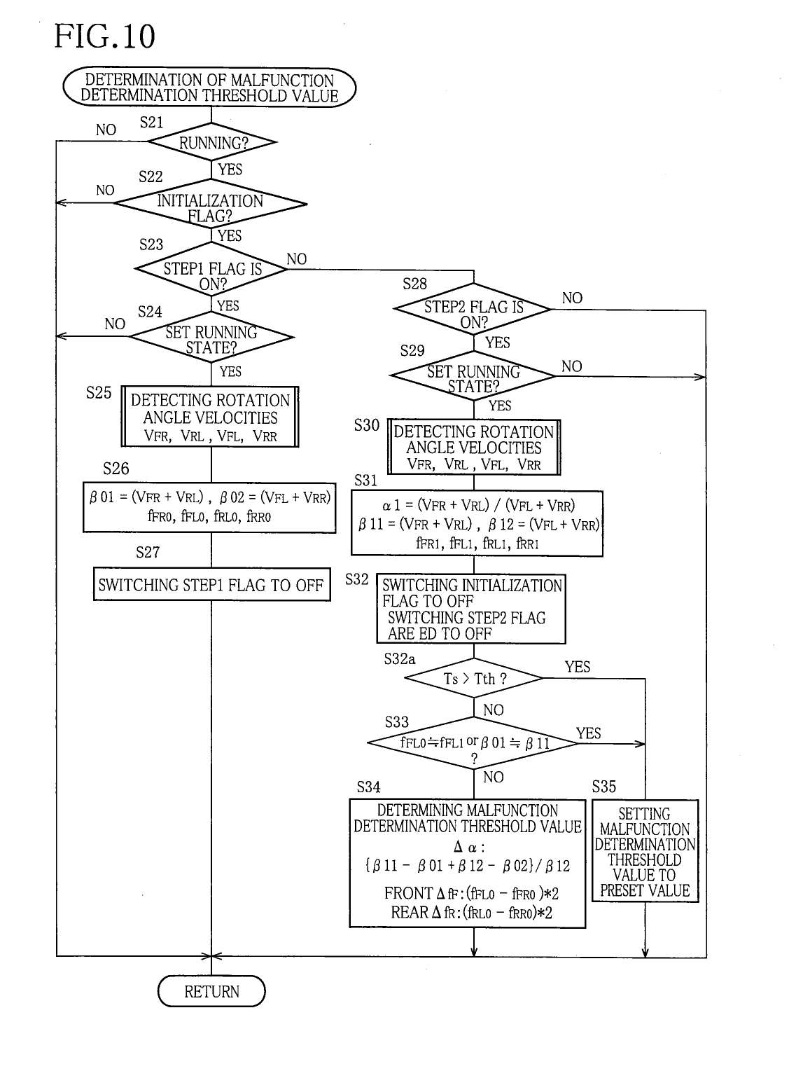

As illustrated in the flow chart in FIG. 9, after the step1 flag is switched to ON at S15, a timer is started at S15a to start measuring a time. After the step2 flag is switched to ON at S19, the measured time is read (Ts) at S19a.

As illustrated in the flow chart in FIG. 10, after the initialization flag and the step2 flag are switched to OFF at S32, it is determined at S32a whether a time Ts is longer than the set time Tth or not. When the time Ts is longer than the set time Tth, it is determined that at least one of the first adjustment air-pressure related value and the second adjustment air-pressure related value is not appropriate for the determination of the malfunction determination threshold values, and the preset value is at S35 set as the malfunction determination threshold value. When the time Ts is shorter than or equal to the set time Tth, the processing at S33 is executed.

At thus described, also in the case where the reliability of the air pressure adjusting operation performed by the operator is low, the determination of the malfunction determination threshold values is inappropriate, reliably avoiding the malfunction determination threshold value from being determined to an inappropriate value, resulting in increase in reliability of the monitoring of the air pressures.

In the present embodiment, a time-dependent appropriateness determiner is constituted by, e.g., the timer 32 and portions of the TPMSECU 20 which store and execute the processings at S15a, S19a, and S32a.

It is noted that the determination may be executed based on a travel distance instead of the elapsed time. That is, when a travel distance between the execution of the processing at S15a and the execution of the processing at S19a is longer than or equal to a set distance, it is determined that the determination of the malfunction determination threshold values is inappropriate. The travel distance in this period can be acquired as a difference of the cumulative travel distances acquired by the travel distance measuring device 34.

The malfunction determination threshold value is acquired as the deviation in the above-described embodiment but may be a value determined by the deviation and the reference air-pressure related value. In this case, the malfunction determination threshold value and the monitoring air-pressure related value are compared with each other to monitor the air pressures.

In the above-described embodiment, in the case where it is determined that at least one of the first adjustment air-pressure related value and the second adjustment air-pressure related value is not appropriate for the determination of the malfunction determination threshold value, the preset value is used, but a value used at the last time may be used. In this case, it is not essential to acquire the preset value, eliminating a need to acquire vibration characteristics, the dynamic load radius, and the like for genuine wheels.

It is not essential that the monitoring dynamic-load-radius related value is set at the value in the above-described embodiment. The monitoring dynamic-load-radius related value may be set at such a value that changes from the reference dynamic-load-radius related value due to lowering of an air pressure of at least one wheel.

For example, the value α may be set in the following equation: α=(V_{FL}/V_{FR})−(V_{RL}/V_{RR}).

It is to be understood that the present invention is not limited to the details of the illustrated embodiments, but may be embodied with various changes and modifications, which may occur to those skilled in the art, without departing from the spirit and scope of the invention.

### EXPLANATION OF REFERENCE NUMERALS

14: Wheel Speed Sensor, 20: TPMSECU, 24: Reset Switch, 28: Display, 36: Lamp

1. An air-pressure monitoring device configured to use a malfunction determination threshold value to monitor whether there is at least one wheel in which an air pressure in a tire is outside an appropriate range among a plurality of wheels provided on a vehicle, the air-pressure monitoring device comprising:
an adjustment air-pressure related value acquirer configured to acquire an adjustment air-pressure related value, as an air-pressure related value related to an air pressure of at least one of the plurality of wheels, based on adjusted information indicating that a state of air pressures of the plurality of wheels has been adjusted to a predetermined state, the adjustment air-pressure related value acquirer being configured to acquire a first adjustment air-pressure related value as the adjustment air-pressure related value based on first adjusted information as the adjusted information which indicates that the state of the air pressures of the plurality of wheels has been adjusted to a first state, the adjustment air-pressure related value acquirer being configured to acquire a second adjustment air-pressure related value as the adjustment air-pressure related value based on second adjusted information as the adjusted information which indicates that the state of the air pressures of the plurality of wheels has been adjusted to a second state different from the first state;
a related-value-difference-dependent appropriateness determiner configured to perform:
when the first adjustment air-pressure related value and the second adjustment air-pressure related value are identical to each other, determining that at least one of the first adjustment air-pressure related value and the second adjustment air-pressure related value is not appropriate for determination of the malfunction determination threshold value; and
when the first adjustment air-pressure related value and the second adjustment air-pressure related value differ from each other, determining that the first adjustment air-pressure related value and the second adjustment air-pressure related value are appropriate for determination of the malfunction determination threshold value; and
a malfunction determination threshold value determiner configured to perform:
when the related-value-difference-dependent appropriateness determiner determines that the at least one of the first adjustment air-pressure related value and the second adjustment air-pressure related value is not appropriate for determination of the malfunction determination threshold value, not executing the determination of the malfunction determination threshold value based on the at least one of the first adjustment air-pressure related value and the second adjustment air-pressure related value; and
when the related-value-difference-dependent appropriateness determiner determines that the first adjustment air-pressure related value and the second adjustment air-pressure related value are appropriate for determination of the malfunction determination threshold value, executing the determination of the malfunction determination threshold value based on the at least one of the first adjustment air-pressure related value and the second adjustment air-pressure related value.

2-3. (canceled)

4. The air-pressure monitoring device according to claim 1, wherein the air-pressure monitoring device comprises a preset value determiner configured to determine a preset value as the malfunction determination threshold value when the malfunction determination threshold value determiner determines that the at least one of the first adjustment air-pressure related value and the second adjustment air-pressure related value is not appropriate for the determination of the malfunction determination threshold value.

5. The air-pressure monitoring device according to claim 4, further comprising:
a monitoring air-pressure related value acquirer configured to acquire a monitoring air-pressure related value as the air-pressure related value when monitoring the air pressure, the monitoring air-pressure related value being related to an air pressure in a tire of at least one of the plurality of wheels; and
an air pressure monitor configured to monitor whether there is at least one wheel in which an air pressure in a tire is outside the appropriate range, among the plurality of wheels at least based on the malfunction determination threshold value and the monitoring air-pressure related value acquired by the monitoring air-pressure related value acquirer.

6. The air-pressure monitoring device according to claim 5, wherein the malfunction determination threshold value determiner comprises an interpolation-dependent determiner configured to determine the malfunction determination threshold value based on a difference between the first adjustment air-pressure related value and the second adjustment air-pressure related value and based on a reference air-pressure related value as the monitoring air-pressure related value which is a value in a case where air pressures in all tires of the plurality of wheels of the vehicle fall within a set range determined by a reference pressure.

7. The air-pressure monitoring device according to claim 5, wherein the malfunction determination threshold value determiner comprises a reference air-pressure related value acquirer configured to, based on reference value update information, acquire and update a reference air-pressure related value as the monitoring air-pressure related value which is a value in a case where air pressures in all tires of the plurality of wheels of the vehicle fall within a set range determined by a reference pressure.

8. The air-pressure monitoring device according to claim 5,
wherein the adjustment air-pressure related value acquirer comprises a rotation angle velocity value acquirer configured to acquire a rotation angle velocity value as the adjustment air-pressure related value, and the rotation angle velocity value is determined by a rotation angle velocity of each of the at least one wheel,
wherein the monitoring air-pressure related value acquirer comprises a dynamic-load-radius related value acquirer configured to acquire a dynamic-load-radius related value as the monitoring air-pressure related value based on a rotation angle velocity of each of the plurality of wheels, and the dynamic-load-radius related value indicates a relationship between dynamic load radiuses of the plurality of wheels, and
wherein the malfunction determination threshold value determiner comprises a rotation-angle-velocity-difference-dependent appropriateness determiner configured to determine whether the determination of the malfunction determination threshold value is appropriate, based on a first rotation angle velocity value as the first adjustment air-pressure related value and a second rotation angle velocity value as the second adjustment air-pressure related value which are acquired by the rotation angle velocity value acquirer.

9. The air-pressure monitoring device according to claim 5,
wherein the adjustment air-pressure related value acquirer comprises a resonant frequency acquirer configured to acquire a resonant frequency of each of the at least one wheel as the adjustment air-pressure related value,
wherein the monitoring air-pressure related value acquirer comprises a resonant frequency acquirer configured to acquire a resonant frequency of each of the plurality of wheels as the monitoring air-pressure related value, and
wherein the malfunction determination threshold value determiner comprises a resonant-frequency-difference-dependent appropriateness determiner configured to determine whether the determination of the malfunction determination threshold value is appropriate, based on at least one of (a) a difference between resonant frequencies of an identical wheel, which are expected to differ from each other in air pressure in an tire, in the first state and the second state and (b) a difference between resonant frequencies of two wheels, which are expected to differ from each other in air pressure in an tire, in one of the first state and the second state.

10. The air-pressure monitoring device according to claim 1, wherein the malfunction determination threshold value determiner comprises a time-dependent appropriateness determiner configured to determine that the at least one of the first adjustment air-pressure related value and the second adjustment air-pressure related value is not appropriate for the determination of the malfunction determination threshold value, when a time elapsed from a point in time when the first adjusted information is output to a point in time when the second adjusted information is output is greater than a predetermined set time.

11. A malfunction-determination-threshold-value determination method of determining a malfunction determination threshold value in an air-pressure monitoring device configured to use the malfunction determination threshold value to monitor whether there is at least one wheel in which an air pressure is outside an appropriate range among a plurality of wheels provided on a vehicle, the malfunction-determination-threshold-value determination method comprises:
a first adjustment air-pressure related value acquiring step of acquiring a first adjustment air-pressure related value based on first adjusted information indicating that a state of air pressures of the plurality of wheels has been adjusted to a predetermined first state, the first adjustment air-pressure related value being an air-pressure related value related to an air pressure of at least one of the plurality of wheels;
a second adjustment air-pressure related value acquiring step of acquiring a second adjustment air-pressure related value based on second adjusted information indicating that the state of the air pressures of the plurality of wheels has been adjusted to a second state different from the first state, the second adjustment air-pressure related value being an air-pressure related value related to the air pressure of the at least one of the plurality of wheels;
an appropriateness determining step of determining that at least one of the first adjustment air-pressure related value and the second adjustment air-pressure related value is not appropriate for determination of the malfunction determination threshold value, when the first adjustment air-pressure related value and the second adjustment air-pressure related value are identical to each other and determining that the first adjustment air-pressure related value and the second adjustment air-pressure related value are is appropriate for determination of the malfunction determination threshold value, when based-en the first adjustment air-pressure related value and the second adjustment air-pressure related value differ from each other; and
a malfunction determination threshold value determining step of:
not executing the determination of the malfunction determination threshold value based on at least one of the first adjustment air-pressure related value and the second adjustment air-pressure related value when it is determined in the appropriateness determining step that the first adjustment air-pressure related value and the second adjustment air-pressure related value are not appropriate for the determination of the malfunction determination threshold value; and
executing the determination of the malfunction determination threshold value based on at least one of the first adjustment air-pressure related value and the second adjustment air-pressure related value when it is determined in the appropriateness determining step that the at least one of the first adjustment air-pressure related value and the second adjustment air-pressure related value is appropriate for the determination of the malfunction determination threshold value.

12. The air-pressure monitoring device according to claim 1, comprising a plurality of wheel speed sensors provided respectively for the plurality of wheels and each configured to detect a rotational speed of a corresponding one of the plurality of wheels,
wherein the adjustment air-pressure related value acquirer comprises a wheel-speed-dependent adjustment air-pressure related value acquirer configured to acquire the adjustment air-pressure related value based on a value detected by at least one of the plurality of wheel speed sensors which corresponds to the at least one wheel.
